(19) United States
(12) Patent Application Publication
(10) Pub. No.: US 2015/0003434 A1
(43) Pub. Date: Jan. 1, 2015

(54) SYSTEMS AND METHODS FOR WIRELESS SCANNING

(71) Applicant: QUALCOMM Incorporated, San Diego, CA (US)

(72) Inventors: Kai SHI, San Jose, CA (US); James Simon CHO, Mountain View, CA (US); Ning ZHANG, Saratoga, CA (US)

(21) Appl. No.: 13/931,320

(22) Filed: Jun. 28, 2013

(51) Int. Cl. H04W 24/10

(52) U.S. Cl. CPC H04W 24/10
USPC 370/338

(57) ABSTRACT

Systems and methods are provided for preferentially locating a candidate channel likely to have an active network during a WLAN scanning process of an increased bandwidth. The candidate channel may be detected using spectral analysis of a received signal that may involve any combination FFT captures and correlation operations associated with detecting packets. Upon identification of a candidate channel, a wireless communications device may switch to that channel to receive and process one or more packets to determine the existence of a BSS available for association.

### FIELD OF THE PRESENT DISCLOSURE

This disclosure generally relates to wireless communication systems and more specifically to systems and methods for increasing throughput.

### BACKGROUND

Wireless local area networks (WLANs) conforming to specifications in the Institute of Electrical and Electronics Engineers (“IEEE”) 802.11 family typically involve a basic service set (BSS) managed by a device acting in the role of an access point (AP). Each BSS may be identified by a service set identifier (SSID), such that a wireless communications device using a WLAN protocol may receive broadcast messages or beacons from access points within range advertising the SSID of their associated networks. The wireless communications device may then manually or automatically select the one or more of the detected networks and perform an association process to create one or more communications links. In order to determine the existence of available networks, the wireless communications device may utilize a scanning process, such as by spending a period of time on each available WLAN channel to receive a beacon or probe response sent by the AP managing the BSS. The scanning process may be used to find usable networks prior to association or may be performed as a background process after associating with one network to determine the availability of alternative networks that may have more desirable characteristics. Scanning may also be performed to assess channel conditions and profile network characteristics.

Conventionally, wireless communications devices using 802.11 protocols may operate on multiple frequency bands, such as the 2.4 GHz band which includes 11 channels and the 5 GHz band which includes 25 channels (16 of the 5 GHz channels are subject to dynamic frequency selection rules that do not permit active scanning). Thus, a considerable amount of time, such as on the order of seconds, may be required to complete a comprehensive scan of the available wireless channels. During this time, the transceiver of the wireless communications device may be devoted to the scanning process and unable to perform other operations. Further, since the wireless communications device must be in active mode rather than a power saving mode when performing the scanning process, a significant amount of energy consumption may also be involved. Accordingly, it would be desirable to provide systems and methods that facilitate the scanning process, such as by identifying available networks more quickly. This disclosure satisfies these and other goals.

### SUMMARY

This disclosure includes methods for scanning for available networks in a wireless communications system over an increased bandwidth. For example, a suitable method may include performing signal analysis over an increased bandwidth, detecting a candidate channel based, at least in part, on the signal analysis, and receiving identification information from a beacon transmitted on the identified wireless channel.

In one aspect, performing signal analysis may involve analyzing Fast Fourier Transform (FFT) samples over the increased bandwidth. Further, detecting the candidate channel may be based, at least in part, on whether a signal magnitude of the FFT samples exceeds a threshold.

In another aspect, performing signal analysis may also involve performing a correlation operation across the increased bandwidth. The correlation operation may include sequentially performing a correlation operation on subsets of the increased bandwidth or may include performing parallel correlation operations on subsets of the increased bandwidth. Further, detecting the candidate channel may be based, at least in part, on a finite impulse response (FIR) power of the correlation operation.

A method of this disclosure may involve switching to the candidate channel to receive the identification information. Alternatively, a method may involve simultaneously decoding outputs from the parallel correlation operations to receive the identification information.

As desired, a list of available networks based, at least in part, on the received identification information may be maintained.

This disclosure may also include systems for scanning for available networks across an increased bandwidth. For example, a suitable wireless communications device may include a transceiver for receiving signals and a scanning controller to perform a signal analysis over an increased bandwidth, wherein the scanning controller may detect a candidate channel based, at least in part, on the signal analysis and the transceiver may receive identification information from a beacon transmitted on the identified wireless channel.

In one aspect, the wireless communications device may include a FFT unit to output FFT samples over the increased bandwidth and the scanning controller may perform the signal analysis by analyzing the FFT samples. The scanning controller may detect the candidate channel based, at least in part, on whether a signal magnitude of the FFT samples exceeds a threshold.

In another aspect, the wireless communications device may include a packet detection unit and the scanning controller may also perform the signal analysis by performing a correlation operation across the increased bandwidth. The packet detection unit may perform the correlation operation by sequentially performing a correlation operation on subsets of the increased bandwidth or may perform the correlation operation by performing parallel correlation operations on subsets of the increased bandwidth. Further, the scanning controller may detect the candidate channel based, at least in part, on a finite impulse response (FIR) power of the correlation operation.

The scanning controller may also switch the transceiver to the candidate channel to receive the identification information. Alternatively, when the packet detection unit performs parallel correlation operations, the wireless communications device may include multiple decode cores to simultaneously decode outputs from the parallel correlation operations to receive the identification information.

As desired, the scanning controller may maintain a list of available networks based, at least in part, on the received identification information.

This disclosure also includes a non-transitory process-readable storage medium for scanning for available networks with a wireless communications device in a wireless communications system, the processor-readable storage medium having instructions thereon, when executed by a processor to cause the wireless communications device to perform signal analysis over an increased bandwidth, detect a candidate channel based, at least in part, on the signal analysis, and receive identification information from a beacon transmitted on the identified wireless channel.

In one aspect, the instructions to perform signal analysis may analyze Fast Fourier Transform (FFT) samples over the increased bandwidth. Further, the instructions to detect the candidate channel may be based, at least in part, on whether a signal magnitude of the FFT samples exceeds a threshold. The instructions to perform signal analysis may also include instructions to perform a correlation operation across the increased bandwidth. The instructions to perform a correlation operation may sequentially perform a correlation operation on subsets of the increased bandwidth. In addition, the instructions to perform a correlation operation may perform parallel correlation operations on subsets of the increased bandwidth. The instructions to detect the candidate channel may be based, at least in part, on a finite impulse response (FIR) power of the correlation operation.

In one aspect, the storage medium may also include instructions to switch to the candidate channel to receive the identification information.

In one aspect, the storage medium may also include instructions to simultaneously decode outputs from the parallel correlation operations to receive the identification information.

In one aspect, the storage medium may also include instructions to maintain a list of available networks based, at least in part, on the received identification information.

This disclosure also includes a wireless communications device for scanning for available networks in a wireless communications system that has a transceiver for receiving signals, means for performing signal analysis over an increased bandwidth on the signals received by the transceiver, means for detecting a candidate channel based, at least in part, on the signal analysis and means for receiving identification information from a beacon transmitted on the identified wireless channel and received by the transceiver.

In one aspect, the means for performing signal analysis may analyze Fast Fourier Transform (FFT) samples over the increased bandwidth. Further, the means for detecting the candidate channel may detect based, at least in part, on whether a signal magnitude of the FFT samples exceeds a threshold. The means for performing signal analysis may also perform a correlation operation across the increased bandwidth. In addition, the means for performing a correlation operation may sequentially perform a correlation operation on subsets of the increased bandwidth. The means for performing a correlation operation may also perform parallel correlation operations on subsets of the increased bandwidth. Still further, the means for detecting the candidate channel may detect based, at least in part, on a finite impulse response (FIR) power of the correlation operation.

In one aspect, the wireless communications device may also have means for switching the transceiver to the candidate channel to receive the identification information.

In one aspect, the wireless communications device may also have means for simultaneously decoding outputs from the parallel correlation operations to receive the identification information with the transceiver.

In one aspect, the wireless communications device may also have means for maintaining a list of available networks based, at least in part, on the received identification information.

### BRIEF DESCRIPTION OF THE DRAWINGS

Further features and advantages will become apparent from the following and more particular description of the preferred embodiments of the disclosure, as illustrated in the accompanying drawings, and in which like referenced characters generally refer to the same parts or elements throughout the views, and in which:

FIG. 1 schematically depicts functional blocks of a wireless communications device configured to scan across an increased bandwidth, according to one embodiment;

FIG. 2 represents an FFT capture output of an FFT unit for detecting a candidate channel, according to one embodiment;

FIG. 3 schematically depicts an incoming signal for input to a packet detection unit, according to one embodiment;

FIG. 4 schematically depicts the output of an auto correlation operation, according to one embodiment;

FIG. 5 schematically depicts the output of a guard interval correlation operation, according to one embodiment;

FIG. 6 schematically depicts the output of a Barker code correlation operation, according to one embodiment; and

FIG. 7 is a flowchart showing an exemplary routine for increased bandwidth scanning, according to one embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present invention and is not intended to represent the only exemplary embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope of the disclosure in any manner and may change depending upon context. Further, sequential terms such as first and second may be used to distinguish similar elements, but may be used in other orders or may change also depending upon context.

Embodiments are described herein with regard to a wireless communications device, which may include any suitable type of user equipment, such as a system, subscriber unit, subscriber station, mobile station, mobile wireless terminal, mobile device, node, device, remote station, remote terminal, terminal, wireless communication device, wireless communication apparatus, user agent, or other client devices. Further examples of a wireless communications device include mobile devices such as a cellular telephone, cordless telephone, Session Initiation Protocol (SIP) phone, smart phone, wireless local loop (WLL) station, personal digital assistant (PDA), laptop, handheld communication device, handheld computing device, satellite radio, wireless modem card and/or another processing device for communicating over a wireless system. Moreover, embodiments may also be described herein with regard to an access point (AP). An AP may be utilized for communicating with one or more wireless nodes and may be termed also be called and exhibit functionality associated with a base station, node, Node B, evolved NodeB (eNB) or other suitable network entity. An AP communicates over the air-interface with wireless terminals. The communication may take place through one or more sectors. The AP may act as a router between the wireless terminal and the rest of the access network, which may include an Internet Protocol (IP) network, by converting received air-interface frames to IP packets. The AP may also coordinate management of attributes for the air interface, and may also be the gateway between a wired network and the wireless network.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

Conventional WLAN wireless channels have a frequency width of 20 MHz. However, current trends in WLAN technologies have resulted in the use of transceivers that are able to operate over high bandwidth channels, including 40 MHz, 80 MHz and 160 MHz. For the purposes of this disclosure, bandwidths greater than 20 MHz are termed increased bandwidth channels. By employing the increased bandwidth capabilities, a wireless communications device according to the techniques of this disclosure may perform a WLAN scanning process over multiple 20 MHz channels simultaneously. Rather than sequentially parking on each wireless channel in order to receive a beacon or a probe response, the wireless communications device may preferentially locate a candidate channel likely to have an active network based on a spectral analysis across the increased bandwidth. The wireless communications device may then switch to the candidate channel if necessary and process one or more packets received on the channel to determine the existence of a BSS available for association.

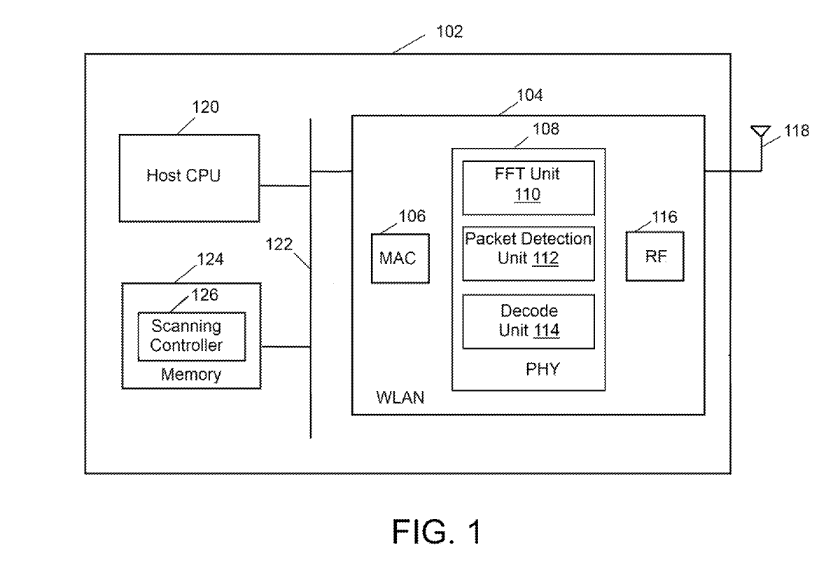

Details regarding one embodiment of a wireless communications device 102 configured to perform increased bandwidth scanning are depicted as high level schematic blocks in FIG. 1. Generally, wireless communications device 102 may employ an architecture in which the lower levels of the WLAN protocol stack are implemented in firmware and hardware modules of WLAN transceiver 104. WLAN transceiver 104 may include media access controller (MAC) 106 that performs functions related to the handling and processing of 802.11 frames of data including verification, acknowledgment, routing, formatting and the like. Incoming and outgoing frames are exchanged between the MAC 106 and a physical (PHY) layer 108 that modulates the frames according to the relevant 802.11 protocol. For example, PHY layer 108 may include Fast Fourier Transform (FFT) unit 110, packet detection unit 112 and decode unit 114, which are discussed in more detail below. WLAN transceiver 104 may also include a radio frequency (RF) block 116 coupled to antenna 118 to provide the analog processing and RF conversion necessary to provide transmission and reception of wireless signals. Although not shown, RF block 116 may include conventional components such as one or more amplifying stages to amplify a received RF signal, one or more filtering stages to remove unwanted bands of frequencies, mixer stages to down-convert the received RF signal, automatic gain control (AGC) functionality to adjust the gain to an appropriate level for a range of received signal amplitude levels, an analog to digital converter (ADC) to convert the received RF signal into a digital signal, and the like. In the depicted embodiment, WLAN transceiver 104 is shown with a single antenna, but one or more antennas may be employed as desired, such as in multiple input, multiple output (MIMO) system or may be shared with other wireless communications protocols.

As indicated, PHY layer 108 may include FFT unit 110 to perform computations on received signals. Analysis of an incoming signal by FFT unit 110 may provide phase and magnitude information within defined frequency ranges, called “bins.” When the received signal is a valid WLAN transmission, FFT unit 110 may demodulate the data signal to recover the payload. In one aspect, FFT unit 110 may measure the magnitude or strength of the received signal at each bin. For example, power may be measured by adding the absolute values or the squares of the in-phase (I) and quadrature (Q) components in the digital baseband signal. Signal power may indicate the presence of data signals being transmitted at the associated frequency or frequencies in the form of a received signal strength indication (RSSI). The output of FFT unit 110, also termed a “FFT capture,” may represent a spectrogram of any received signals over the frequencies associated with the increased bandwidth and may be analyzed as discussed below to identify the potential presence of an active BSS.

PHY layer 108 may also include packet detection unit 112 to help identify the presence of WLAN information in a received signal. For example, packet detection unit 112 may be configured to identify the presence of a training field in a received signal. In one aspect, a valid WLAN packet of information may include a preamble having a repeating pattern of known information, such as a Barker code, in the form of short training fields (STF). Packet detection unit 112 may use one or more correlators to generate a cross correlation signal proportional to the degree with which a received signal matches the known pattern. As desired, packet detection unit 112 may also use one or more correlators to generate a self correlation signal proportional to the degree with which a subsequently received signal matches a previously received signal to provide an indication of the presence of the cyclically repeating training fields that may characterize a WLAN packet. As described in further detail below, packet detection unit 112 may include a single detection chain or multiple, parallel chains, each capable of processing a subset of the increased bandwidth. In one embodiment, a packet detection chain may process 20 MHz of bandwidth. In another embodiment, four packet detection chains may be employed in parallel to process 80 MHz of bandwidth simultaneously.

Further, PHY layer 108 may also include decode unit 114 as indicated for performing appropriate digital signal processing operations on a received signal, including demodulating, deinterleaving, and decoding, for example, depending on the encoding applied before transmission. As known in the art, decode unit 114 may employ timing and frequency offset information and/or channel estimation information from packet detection unit 112 to perform the digital signal processing operations. Decode unit 114 may employ a single core or multiple, parallel cores, each configured to process the output of one of the packet detection chains of packet detection unit 112. Thus, in one embodiment, a single core may be employed to serially process one or more packet detection chain outputs. In another embodiment, one decode core may be provided for each packet detection chain, to allow for parallel processing of the outputs and recovery of information from received signal, such as identification information for an active network on the candidate channel. The identification information may include the SSID of the network.

Wireless communications device 102 may also include host CPU 120 configured to perform the various computations and operations involved with the functioning of wireless communications device 102. As shown, host CPU 120 is coupled to WLAN transceiver 104 through bus 122, which may be implemented as a peripheral component interconnect express (PCIe) bus, a universal serial bus (USB), a universal asynchronous receiver/transmitter (UART) serial bus, a suitable advanced microcontroller bus architecture (AMBA) interface, a serial digital input output (SDIO) bus, or other equivalent interface. In one embodiment, upper layers of the protocol stacks of the WLAN and supplementary systems may be implemented as software instructions stored in memory 124, that may be accessed by host CPU 120 over bus 122.

Wireless communications device 102 may include scanning controller 126 implemented as software instructions stored in memory 124 as depicted for the embodiment shown in FIG. 1. In other embodiments, scanning controller 126 may be implemented as a dedicated hardware circuit coupled to MAC 106 and PHY layer 108, or as any suitable combination of software, firmware and hardware. Although wireless communications device 102 is depicted with one receiver chain, any number of receiver chains may be employed and may include appropriate functional blocks to combine the outputs from various receiver chains.

In one embodiment, wireless communications device 102 may perform a scanning operation that includes obtaining FFT samples across an increased bandwidth with FFT unit 110. If a signal having a strength exceeding a predefined threshold is detected, scanning controller 126 may be configured to interpret that the signal is likely to represent a transmission from a network within range. As noted above, the strength of the received signal may be measured as RSSI. Additionally, the number of adjacent FFT bins exceeding the threshold may be analyzed to determine if the received signal has wideband characteristics of a WLAN packet or narrowband characteristics that may be associated with noise or other interference. The spectral analysis of the FFT capture may also include accommodating factors such as ADC power and saturation, RF saturation and/or the potential of in-band signal droop. Further, detection parameters may be adjusted over time as patterns that correlate with the existence of active networks emerge. For example, different portions of the increased bandwidth spectrum may have different response characteristics such that different thresholds may be applied to depending upon the relative location within the increased bandwidth, or selection may be otherwise biased, upon determination of non-uniform signal response. In another embodiment, the function of FFT unit 110 may be performed using a group of digital band-pass filters and digital mixers in a filter bank configuration to separate the received signal into multiple frequency sub-bands as desired.

Upon detection of a candidate signal corresponding to characteristics of WLAN activity, WLAN transceiver 104 may be configured to switch to the corresponding 20 MHz channel as the primary channel and proceed with decoding the received signal. If a plurality of signals meeting the criteria are detected, WLAN transceiver 104 may switch to the strongest 20 MHz channel first, and then sequentially scan the other identified channels if desired. Wireless communications device 102 may than receive and decode a beacon or other transmission on that channel to recover the information and determine the existence of an active network, such as by receiving identification information in the form of an SSID for the active network.

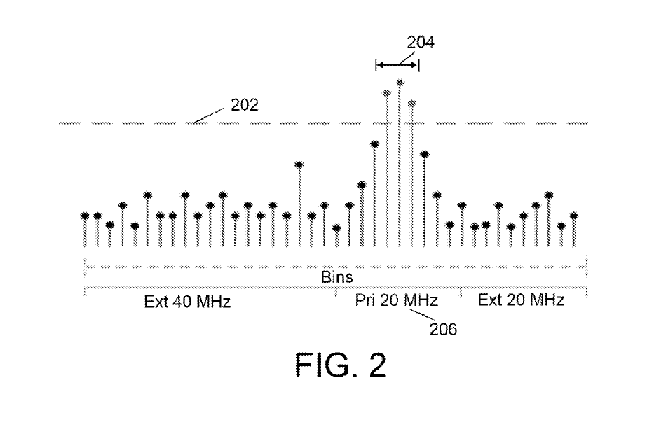

An exemplary FFT capture representing of the output of FFT unit 110 is depicted in FIG. 2. As shown, the signal magnitude at each bin may be compared to a threshold 202. Upon determination of a sufficient group of bins exceeding the threshold, such as group 204, scanning controller 126 may switch WLAN transceiver to primary 20 MHz channel 206 to receive transmissions on that channel. Upon successful reception of a beacon, wireless communications device 102 may determine the SSID and, optionally, other characteristics of the associated network.

Depending upon the configuration of wireless communications device 102, such as the parameters of the AGC, sensitivity of WLAN scanning using FFT unit 110 may be approximately −85 dBm. To provide increased sensitivity, scanning controller 126 may also obtain output from packet detection unit 112 to help identify one or more received signals likely to represent a transmission from a network within range.

PHY layer 108 may also include packet detection unit 112 to help identify the presence of WLAN information in a received signal. As discussed above, packet detection unit 112 may have one or more detection chains providing a correlation output that may be used to identify a training field present in a valid WLAN packet. For example, the correlation output may be the finite impulse response (FIR) power. As such, each detection chain may process a subset of frequencies of the increased bandwidth, such as a subset having a bandwidth of 20 MHz and output a FIR power at periods corresponding to the duration of the training field, such as every 0.8 μs. In one embodiment, packet detection unit 112 may have a single packet detection chain and may be configured to sequentially scan each subset of the increased bandwidth. In other embodiments, parallel detection chains may be employed to simultaneously process multiple subsets of the increased bandwidth. In one embodiment, four parallel chains having a bandwidth of 20 MHz each may be used to process an increased bandwidth of 80 MHz simultaneously. By employing multiple, parallel detection chains, a more rapid scan may be performed, but may involve increased hardware and system requirements and/or increased power consumption. The output of packet detection unit 112 may provide a more sensitive detection of candidate signals, such as with a sensitivity of approximately −90 dBm or greater, depending upon the configuration and characteristics of WLAN transceiver 104 and the amount of time spent performing the scan.

Accordingly, the output of packet detection unit 112 may be used by scanning controller 126 to interpret a received signal as likely to represent a transmission from a network within range. WLAN transceiver 104 may switch to the primary channel corresponding to an increased correlation signal to receive a transmission, such as a beacon. Since signal detection through packet detection unit 112 may be relatively more sensitive than through FFT unit 110, WLAN transceiver 104 may preferentially switch to a primary channel identified by FFT unit 110 as it may represent a stronger signal. Alternatively, or if no signal is detected by FFT unit 110, WLAN transceiver 104 may switch to the primary channel identified by packet detection unit 112 only if the received signal is stronger than the current channel.

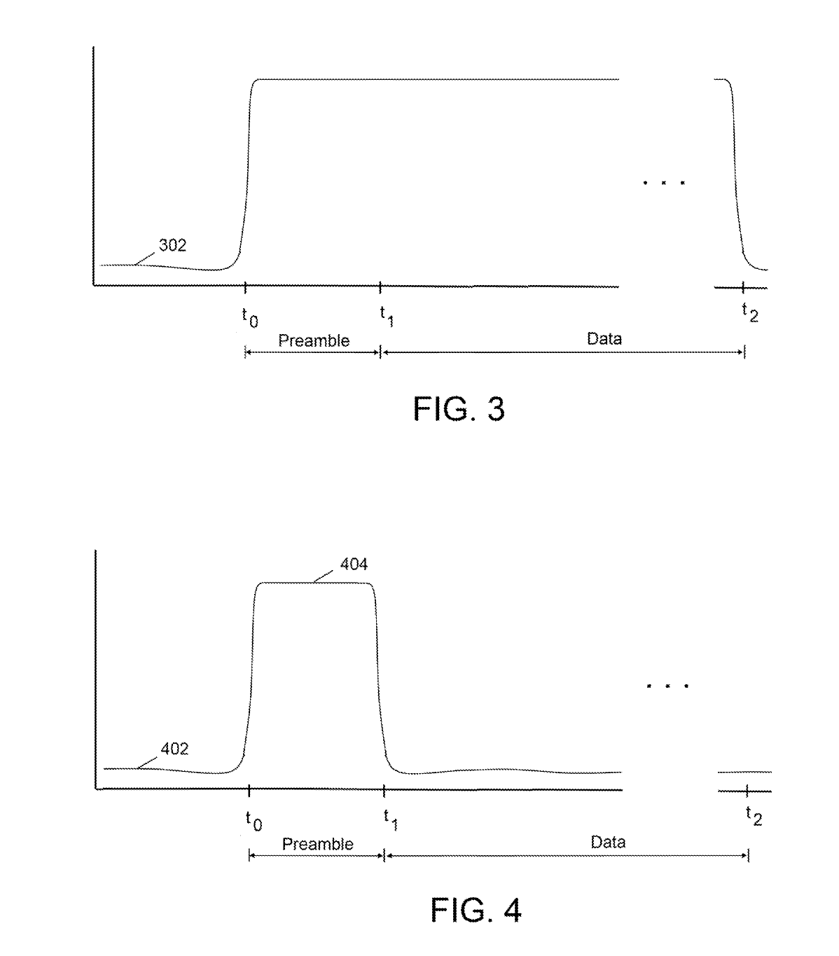

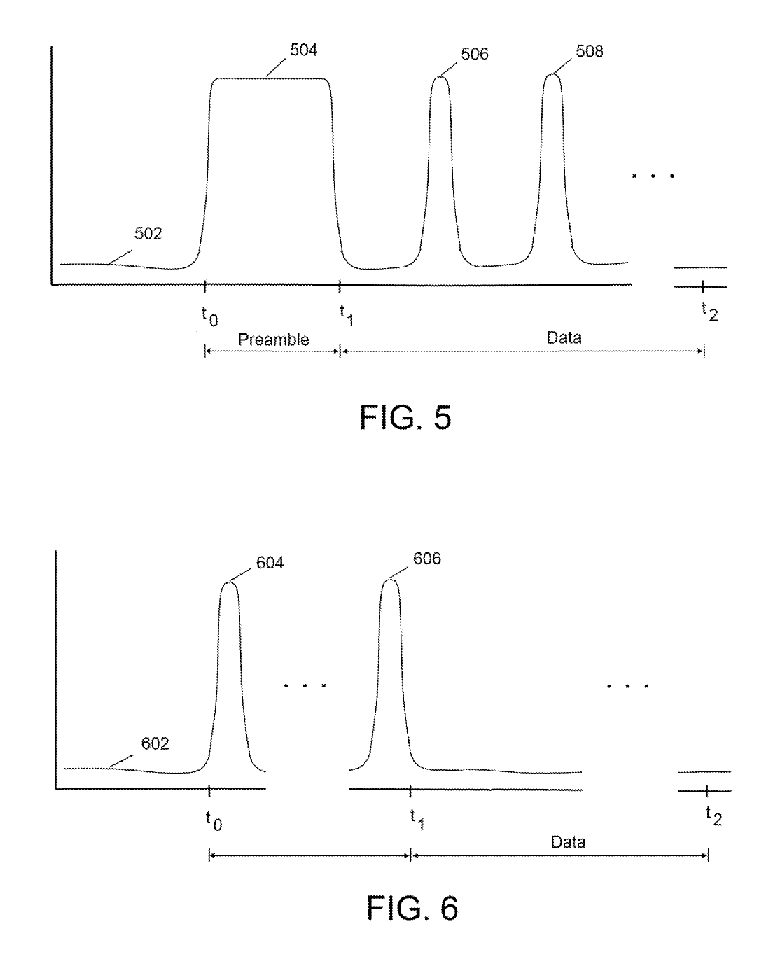

In one aspect, the correlation operations performed by packet detection unit 112 may reflect the type of packet being received. FIG. 3 schematically depicts an incoming signal. Trace 302 represents the input provided by packet detection unit 112 of a signal as received by antenna 118. An incoming signal having a valid packet may include a preamble portion, as indicated by time t₀ to t₁, and a data portion, as indicated by time t₁ to t₂. Various exemplary outputs resulting from different correlation operations are depicted in FIGS. 4-6. For example, FIG. 4 represents the output of an auto correlation operation. Trace 402 exhibits lobe 404 corresponding to the preamble of an incoming packet, resulting from correlation over a 0.8 μs period. As desired, the output shown in FIG. 4 may be used to detect the preamble of a packet conforming to 802.11 a/g/n/ac protocols. Next, FIG. 5 represents the output of a guard interval (GI) correlation operation. Trace 502 exhibits an initial lobe 504 corresponding to the preamble and lobes 504 and 506 corresponding to the GI preceding each orthogonal frequency-division multiplexing (OFDM) symbol that form the body of the packet data. The correlation peaks corresponding to the GI of OFDM symbols, such as lobes 506 and 508, may occur at intervals 3.6 μs or 4 μs, reflecting a 3.2 μs correlation interval and an integration time of 0.4 μs or 0.8 μs, respectively. As desired, the output shown in FIG. 5 may be used to detect the preamble of a packet conforming to 802.11 a/g/n/ac protocols. Further, FIG. 6 represents the output of a Barker code correlation operation. Trace 602 exhibits lobes 604 and 606 having a pulse width of approximately 1 μs corresponding to the STFs in the preamble of an incoming packet. As desired, the output shown in FIG. 6 may be used to detect the preamble of a packet conforming to the 802.11 b protocols.

As described above, packet detection unit 112 may employ parallel detection chains to simultaneously scan multiple subsets of the increased bandwidth. In one embodiment, decode unit 114 may employ a single processing core to receive the output from one of the parallel detection chains. The techniques described above with regard to FFT unit 110 and packet detection unit 112 may be applied to spectrally analyze received signals across an increased bandwidth to identify a primary 20 MHz channel, for example, having a signal that is likely to represent a transmission from a network within range. The single processing core of decode unit 114 may then be used to receive output from a detection chain corresponding to the primary 20 MHz channel so that a beacon transmitted on that channel may be properly decoded and the information received. In another embodiment, decode unit 114 may employ multiple processing cores, such as one for each of the packet detection chains. As such, decode unit 114 may be able to simultaneously process multiple subsets of the increased bandwidth. For example, in an embodiment having four packet detection chains operating at bandwidths of 20 MHz, decode unit 114 may provide four decode processing cores to simultaneously receive the outputs from the detection chains and directly recover a beacon transmitted within the increased bandwidth, without the need to explicitly switch channels to a primary 20 MHz channel.

Thus, according to the techniques described above, spectral analysis of an increased bandwidth to identify a candidate channel likely to have an active network may include analyzing output from FFT unit 110 and/or packet detection unit 112. WLAN scanning using such techniques may provide more rapid identification of available networks as compared to a conventional WLAN scanning process. Although the increased bandwidth scanning techniques of this disclosure may not have the same sensitivity as conventional WLAN scanning, the ability to find relatively strong networks may be desirable, particularly when wireless communications device 102 is already associated with a WLAN and is performing the increased bandwidth scanning process in the background to identify alternative available networks that may offer improved performance. In another aspect, the increased bandwidth scanning processes of this disclosure may be combined with conventional WLAN scanning at desired usage rates. For example, the increased bandwidth scanning may be used more often due to its efficiencies, while the conventional WLAN scanning may be performed more infrequently to facilitate comprehensive identification of networks within range. In another aspect, the choice between increased bandwidth scanning and conventional WLAN scanning may be dictated by the association state of wireless communications device 102. When wireless communications device 102 is currently associated with a BSS, an increased bandwidth scanning process may be performed in the background to identify the potential existence of other networks and a conventional WLAN scan may be performed when wireless communications device 102 is unassociated.

As described above, the increased bandwidth scanning techniques of this disclosure may be used to identify a candidate channel likely to have an active network. In a busy network environment, detection of candidate channels may occur relatively more frequently. Further, beacons on different channels may overlap in time or normal packet detection on the current channel may interfere with beacon reception. To help offset a potential decrease in performance, such as due to WLAN transceiver 104 switching to the primary channel identified in the scans too frequently, various strategies may be employed. For example, operations at PHY layer 108 may involve aborting the reception of an incoming packet during an increased bandwidth scan. Any suitable trigger may be used to abort reception of an incoming packet, including after determining that the signal strength is too low, such as when looking for alternative networks, after determining the incoming packet is not of interest, such as when the packet is not a beacon, or after receiving desired portions of the packet, such as the SSID. By aborting reception of an incoming packet, reception of other packets may be performed without the need to wait for the incoming packet to finish. Further, PHY layer 108 may use information carried by an incoming packet to adjust reception behavior. For example, when an incoming packet is not of interest, the length of the packet may be determined, such as from the legacy signal (L-SIG) field or other suitable field. Consequently, WLAN transceiver 104 may switch from this channel to a candidate channel for the duration of this period as part of an increased bandwidth scan without reducing performance. Still further, to mitigate any potential missed beacons during the increased bandwidth scan, the SSID of all received traffic in addition to the beacons may be monitored. In turn, a list of SSIDs obtained from all traffic may be compared to SSIDs on an association list to reduce passive scan times.

In another embodiment, detection of active WLAN traffic using the increased bandwidth scanning techniques of this disclosure may trigger a subsequent active scanning process. For example, wireless communications device 102 may send a probe request to provoke a response from an AP. An active scan may be allowed without violating dynamic frequency selection (DFS) requirements as the presence of active WLAN traffic indicates that the AP operating on that channel has not detected radar signals.

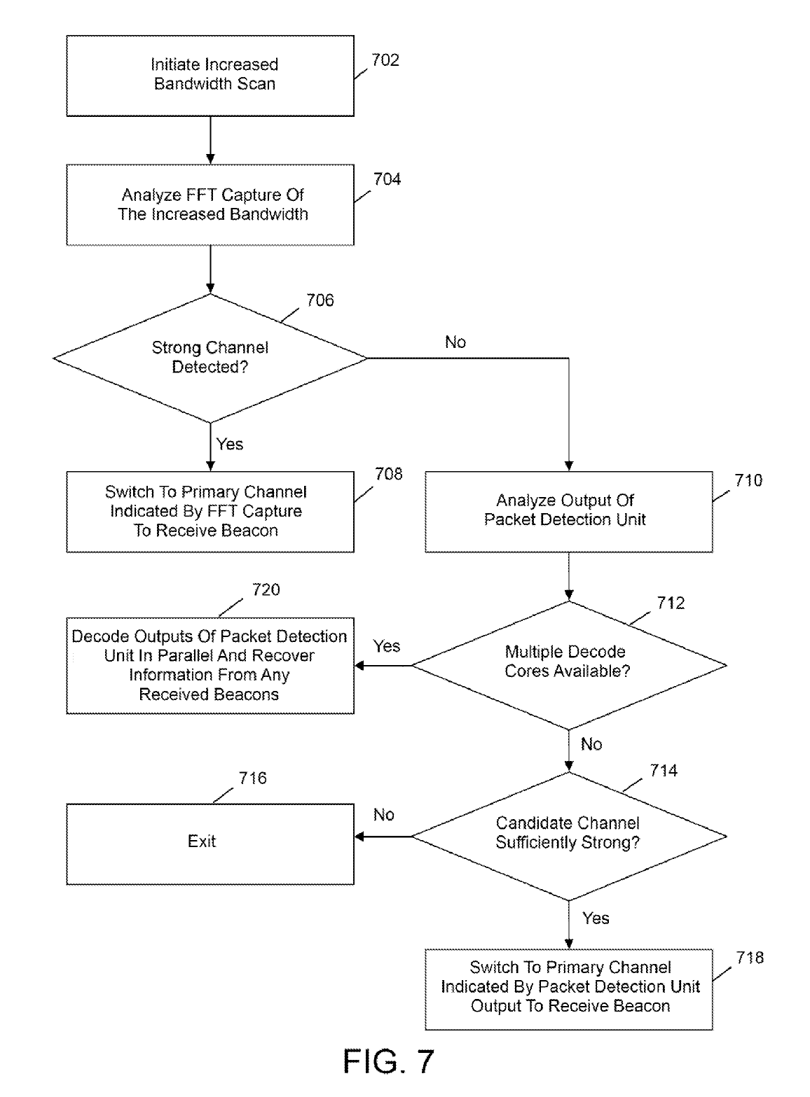

To help illustrate aspects of the increased bandwidth scans described above, FIG. 7 represents a flowchart showing one exemplary routine of the disclosure. Beginning with 702, scanning controller 126 may initiate an increased bandwidth scan. The increased bandwidth scan may be performed periodically as a background procedure to help identify alternative available networks that may offer improved performance or may be triggered by an event such as WLAN transceiver 104 being activated, a change in association state or any other suitable condition. In 704, scanning controller 126 may receive an FFT capture of the increased bandwidth output by FFT unit 110. Based on a spectral analysis of the FFT capture, scanning controller 126 may determine whether a received signal has characteristics that may be associated with the existence of an active network in 706, such as whether a sufficient number of FFT bins have an RSSI exceeding a threshold. If the output from FFT unit 110 indicates a candidate channel exists, the routine may continue to 708 such that WLAN transceiver 104 switches to a primary channel indicated by the FFT capture, allowing any beacons that may be transmitted on that channel to be received and the information recovered.

Alternatively, if no channels of sufficient strength are identified in 706, the routine may branch to 710 and scanning controller may perform a spectral analysis of an output from packet detection unit 112. As discussed above, this may involve sequentially analyzing subsets of the increased bandwidth using a single packet detection chain or may involve analyzing multiple subsets of the increased bandwidth using parallel packet detection chains. If decode unit 114 employs a single processing core as represented by 712, scanning controller 126 may determine whether candidate channel identified by the output of packet detection unit 112 is sufficiently stronger than the signal associated with a currently associated network in 714. In one aspect, this may include measuring the FIR power of the subset of the increased bandwidth exhibiting the strongest correlation. If the candidate channel is not sufficiently strong, the routine may exit is indicated in 716. Otherwise, scanning controller 126 may switch WLAN transceiver 104 to a desired channel as determined by the output of packet detection unit 112 so that a beacon transmitted on the channel may be received in 718. If decode unit 114 has multiple processing cores available as indicated by 712, the routine may instead flow to 720 so that the processing cores decode the output provided by the parallel packet detection chains simultaneously to recover information from any received beacons.

Described herein are presently preferred embodiments. However, one skilled in the art will understand that the principles of this disclosure can be extended easily with appropriate modifications to other applications.

What is claimed is:

1. A method for scanning for available networks in a wireless communications system, comprising:
performing signal analysis over an increased bandwidth;
detecting a candidate channel based, at least in part, on the signal analysis; and
receiving identification information from a beacon transmitted on the identified wireless channel.

2. The method of claim 1, wherein performing signal analysis comprises analyzing Fast Fourier Transform (FFT) samples over the increased bandwidth.

3. The method of claim 2, wherein detecting the candidate channel is based, at least in part, on whether a signal magnitude of the FFT samples exceeds a threshold.

4. The method of claim 2, wherein performing signal analysis further comprises performing a correlation operation across the increased bandwidth.

5. The method of claim 4, wherein performing a correlation operation comprises sequentially performing a correlation operation on subsets of the increased bandwidth.

6. The method of claim 4, wherein performing a correlation operation comprises performing parallel correlation operations on subsets of the increased bandwidth.

7. The method of claim 4, wherein detecting the candidate channel is based, at least in part, on a finite impulse response (FIR) power of the correlation operation.

8. The method of claim 1, further comprising switching to the candidate channel to receive the identification information.

9. The method of claim 6, further comprising simultaneously decoding outputs from the parallel correlation operations to receive the identification information.

10. The method of claim 1, further comprising maintaining a list of available networks based, at least in part, on the received identification information.

11. A wireless communications device for scanning for available networks in a wireless communications system, comprising:
a transceiver for receiving signals; and
a scanning controller to perform a signal analysis over an increased bandwidth, wherein the scanning controller to detect a candidate channel based, at least in part, on the signal analysis and the transceiver to receive identification information from a beacon transmitted on the identified wireless channel.

12. The wireless communications device of claim 11, wherein the wireless communications device further comprises a Fast Fourier Transform (FFT) unit to output FFT samples over the increased bandwidth and wherein the scanning controller to perform the signal analysis by analyzing the FFT samples.

13. The wireless communications device of claim 12, wherein the scanning controller to detect the candidate channel based, at least in part, on whether a signal magnitude of the FFT samples exceeds a threshold.

14. The wireless communications device of claim 12, wherein the wireless communications device further comprises a packet detection unit and wherein the scanning controller further to perform the signal analysis by performing a correlation operation across the increased bandwidth.

15. The wireless communications device of claim 14, wherein the packet detection unit to perform the correlation operation by sequentially performing a correlation operation on subsets of the increased bandwidth.

16. The wireless communications device of claim 14, wherein the packet detection unit to perform the correlation operation by performing parallel correlation operations on subsets of the increased bandwidth.

17. The wireless communications device of claim 14, wherein the scanning controller to detect the candidate channel based, at least in part, on a finite impulse response (FIR) power of the correlation operation.

18. The wireless communications device of claim 11, wherein the scanning controller further to switch the transceiver to the candidate channel to receive the identification information.

19. The wireless communications device of claim 16, wherein the wireless communications device further comprises multiple decode cores to simultaneously decode outputs from the parallel correlation operations to receive the identification information.

20. The wireless communications device of claim 11, wherein the scanning controller further to maintain a list of available networks based, at least in part, on the received identification information.

21. A non-transitory process-readable storage medium for scanning for available networks with a wireless communications device in a wireless communications system, the processor-readable storage medium having instructions thereon, when executed by a processor to cause the wireless communications device to:
perform signal analysis over an increased bandwidth;
detect a candidate channel based, at least in part, on the signal analysis; and
receive identification information from a beacon transmitted on the identified wireless channel.

22. The storage medium of claim 21, wherein the instructions to perform signal analysis comprise instructions to analyze Fast Fourier Transform (FFT) samples over the increased bandwidth.

23. The storage medium of claim 22, wherein the instructions to detect the candidate channel are based, at least in part, on whether a signal magnitude of the FFT samples exceeds a threshold.

24. The storage medium of claim 22, wherein the instructions to perform signal analysis further comprise instructions to perform a correlation operation across the increased bandwidth.

25. The storage medium of claim 24, wherein the instructions to perform a correlation operation comprise instructions to sequentially perform a correlation operation on subsets of the increased bandwidth.

26. The storage medium of claim 24, wherein the instructions to perform a correlation operation comprise instructions to perform parallel correlation operations on subsets of the increased bandwidth.

27. The storage medium of claim 24, wherein the instructions to detect the candidate channel are based, at least in part, on a finite impulse response (FIR) power of the correlation operation.

28. The storage medium of claim 21, further comprising instructions to switch to the candidate channel to receive the identification information.

29. The storage medium of claim 26, further comprising instructions to simultaneously decode outputs from the parallel correlation operations to receive the identification information.

30. The storage medium of claim 1, further comprising instructions to maintain a list of available networks based, at least in part, on the received identification information.

31. A wireless communications device for scanning for available networks in a wireless communications system, comprising:
a transceiver for receiving signals;
means for performing signal analysis over an increased bandwidth on the signals received by the transceiver;
means for detecting a candidate channel based, at least in part, on the signal analysis; and
means for receiving identification information from a beacon transmitted on the identified wireless channel and received by the transceiver.

32. The wireless communications device of claim 31, wherein the means for performing signal analysis analyzes Fast Fourier Transform (FFT) samples over the increased bandwidth.

33. The wireless communications device of claim 32, wherein the means for detecting the candidate channel detects based, at least in part, on whether a signal magnitude of the FFT samples exceeds a threshold.

34. The wireless communications device of claim 32, wherein the means for performing signal analysis further perform a correlation operation across the increased bandwidth.

35. The wireless communications device of claim 34, wherein the means for performing a correlation operation sequentially performs a correlation operation on subsets of the increased bandwidth.

36. The wireless communications device of claim 34, wherein the means for performing a correlation operation performs parallel correlation operations on subsets of the increased bandwidth.

37. The wireless communications device of claim 34, wherein the means for detecting the candidate channel detects based, at least in part, on a finite impulse response (FIR) power of the correlation operation.

38. The wireless communications device of claim 31, further comprising means for switching the transceiver to the candidate channel to receive the identification information.

39. The wireless communications device of claim 36, further comprising means for simultaneously decoding outputs from the parallel correlation operations to receive the identification information with the transceiver.

40. The wireless communications device of claim 31, further comprising means for maintaining a list of available networks based, at least in part, on the received identification information.
